(19) United States
(12) Patent Application Publication
(10) Pub. No.: US 2019/0143812 A1
(43) Pub. Date: May 16, 2019

(54) VEHICLE AND CORRESPONDING USE

(71) Applicant: EXEL INDUSTRIES, Epernay (FR)

(72) Inventor: Bernhard FUCHS, Regensburg (DE)

(21) Appl. No.: 16/186,134

(22) Filed: Nov. 9, 2018

(30) Foreign Application Priority Data
Nov. 10, 2017 (EP) 17306565.7

(51) Int. Cl. B60K 23/08; B60K 17/356; B60C 23/00; A01C 23/04; A01C 15/00

(52) U.S. Cl. CPC B60K 23/0808; B60K 17/356; A01C 15/003; A01C 23/047; B60C 23/001

(57) ABSTRACT

A vehicle includes a vehicle frame, front wheels, and rear wheels. The vehicle also includes front drive means for driving the front wheels with a front nominal speed, rear drive means for driving the rear wheels with a rear nominal speed, and control means. The control means are adapted and configured for selectively controlling the front drive means and the rear drive means so that either the front nominal speed is different from the rear nominal speed, or so that the front nominal speed is equal to the rear nominal speed.

### CROSS-REFERENCE TO RELATED APPLICATIONS

This application claims priority to European Patent Application No. 17306565.7, filed Nov. 10, 2017, the entirety of which is hereby incorporated by reference.

### STATEMENT REGARDING FEDERALLY SPONSORED RESEARCH OR DEVELOPMENT

Not Applicable.

### APPENDIX

Not Applicable.

### BACKGROUND

The present invention concerns a vehicle comprising a vehicle frame, front wheels, and rear wheels.

Agricultural vehicles used for distributing fertilizing agents are known in the state of the art.

Distributing fertilizing agents, in particular fertilizing agents containing nitrogen, can lead to loss of nitrogen into the environment when done during periods in which the vegetation does not need any nitrogen. In order to limit the environmental impact of fertilizing agent in the future it will be necessary to distribute the fertilizing agents only during specific periods and in particular during periods in which the nitrogen need of the plants is relatively high, which is generally during spring time.

Distributing the nitrogen fertilizers, in particular during these periods, has however the following constraints.

The soil is often saturated with water. The weather is not stable, which leads to short distribution windows.

Another problem is the possibility of loss of ammonium into the air in case the distribution technology is not adapted to the needs.

Another problem generated by fertilizer distribution, in particular during spring time, in Grass land and in standing crop is the danger of damage to the plants or crops or damages to the soil structure, as well as lateral skidding of the vehicle when driving along lateral inclinations (i.e. perpendicular or transversally to a slope). The problem of skidding appears predominantly when the crops are in rows and/or when the soil includes wheel tracks (i.e. portions of soil in which previously wheels have run and which have generally little vegetation).

Due to the above-mentioned constraints, the distribution of fertilizer and in particular of liquid manure leads to a high impact and stress to the drivers as they need to work in shifts and often during night time. The drivers also need more and more to check and monitor a number of important parameters, such as for example data of fertilizing agent sensors.

A need exists therefore for vehicles and in particular agricultural vehicles which are able to be displaced with little impact on the vegetation and/or with high directional stability and/or requiring little attention of the driver.

### SUMMARY

In order to solve one or more of these problems, the invention provides a vehicle and, in particular, a vehicle having the following features. The vehicle has front drive means for driving the front wheels with a front nominal speed, rear drive means for driving the rear wheels with a rear nominal speed, and control means adapted and configured for selectively controlling the front drive means and the rear drive means. The control means control the drive means so that either the front nominal speed (VFR, VFL) is different from the rear nominal speed (VRR, VRL), in particular so that the front nominal speed is greater or smaller than the rear nominal speed, or so that the front nominal speed is equal to the rear nominal speed. The difference between the front nominal speed and the rear nominal speed is defined as “lead”.

The vehicle according to the invention can also comprise generally a vehicle frame, front wheels, and rear wheels. The vehicle according to the invention can comprise one or more of the following features, taken in every technically feasible combination. The vehicle may include drive mode control means defining one or more of the following drive modes: A) a neutral drive mode in which the front nominal speed is set equal to the rear nominal speed; B) a small lead drive mode in which the front nominal speed is higher than the rear nominal speed, in particular in a range from 0% to 3%; and C) a high lead drive mode in which the front nominal speed is higher than the rear nominal speed and the difference in front nominal speed to the rear nominal speed is higher than in the small lead drive mode, in particular the difference being in a range from 2 to 5%. The vehicle may include lateral inclination information means, in particular a lateral inclination sensor, adapted to and configured for indicating the lateral inclination of the vehicle frame or of the soil on which the vehicle is placed with respect to a horizontal plane. The lateral inclination information means is connected to the control means. The control means are adapted to and configured for controlling, in particular selectively controlling, the front drive means and the rear drive means according to one of the two following terrain modes: 1) horizontal plane terrain mode, executed when the lateral inclination information means indicate a horizontal position of the vehicle or a position of the vehicle parallel to a slope; and 2) lateral inclination terrain mode, executed when the lateral inclination information means indicate a lateral inclination of the vehicle with respect to a horizontal plane. The control means are adapted to and configured for controlling the lead as a function of the lateral inclination information.

The control means may include a vegetation selector adapted to and configured for switching the control means into one of the vegetation modes, indicating the vegetation type on which the vehicle is displaced including A) grassland mode—the terrain comprises one or more of the following: grassland, standing plants, stubble, intermediate crops; and B) Row crop mode—the terrain comprises row crops or the terrain comprises wheel tracks.

The control means are adapted and configured for controlling the vehicle according to one, several or all of the following drive strategies: DRIVE STRATEGY 1: Vegetation mode=Grassland mode and Terrain mode=horizontal plane terrain mode: the vehicle is driven in neutral drive mode; DRIVE STRATEGY 2: Vegetation mode=Grassland mode and Terrain mode=lateral inclination terrain mode: the vehicle is driven in small lead drive mode; DRIVE STRATEGY 3: Vegetation mode=Row crop mode and Terrain mode=horizontal plane terrain mode: the vehicle is driven in neutral drive mode; and DRIVE STRATEGY 4: Vegetation selector=Row crop mode and Terrain mode=lateral inclination terrain mode: the vehicle is driven in high lead drive mode. At least one of the front wheels, in particular each front wheel, includes a front tire having a front air chamber, and/or at least one of the rear wheels, in particular each rear wheel includes a rear tire having a rear air chamber. The vehicle includes furthermore a pressure control device adapted to and configured for controlling the fluid pressure, in particular air pressure, in at least one of the front and/or rear air chambers, and in particular in each of the air chambers.

In DRIVE STRATEGY 1, a first, namely a relatively small, air chamber pressure is set, and preferably the air chamber pressure is set to be identical in each air chamber. In DRIVE STRATEGY 2, the air chamber pressure is adjusted as a function of the lateral inclination so that a lower ground wheel has an air pressure higher than the corresponding higher ground wheel. In DRIVE STRATEGY 3, the air pressure is adjusted as a function of a needed traction force. In DRIVE STRATEGY 4, the air chamber pressure is adjusted as a function of the lateral inclination so that a lower ground wheel has an air pressure higher than the corresponding higher ground wheel.

The control means may be adapted and configured for controlling the vehicle according to one, several or all of the following supplementary strategies, which are applied in addition and preferably simultaneously to each of the DRIVE STRATEGIES 1 to 4: DRIVE STRATEGY 5—Turn mode: Supplementary to the selected drive strategy among DRIVE STRATEGY 1 to 4: the lead is increased with respect to the applied DRIVE STRATEGY 1 to 4, in particular the lead is increased at least by 1% point increase; DRIVE STRATEGY 6—Reverse drive: With respect to the applied DRIVE STRATEGY 1 to 4, additionally the front nominal speed is applied to the rear wheels with a reverse rotation direction and the rear nominal speed is applied to the front nominal speed with a reverse direction; and DRIVE STRATEGY 7—Road travel: the neutral drive mode is set and the air chamber pressure is set to being higher than during the DRIVE STRATEGY 1 to 4, in particular the air chamber pressure is at least 0.1 bar and in particular 0.4 bar higher than during DRIVE STRATEGIES 1 to 4.

The control means may be adapted to control the front drive means and the rear drive means so that the maximum difference between the front nominal speed and the rear nominal speed is greater than 1%, preferably greater or equal than 2% and more preferably between 2 and 4%. The control means may be adapted to control the front drive means independently from the rear drive means, namely the front nominal speed can be set from zero to a maximum front nominal speed and the rear nominal speed can be set from zero to a maximum rear nominal speed independently from the front nominal speed.

The front drive means include a front motor, in particular a hydraulic motor or an electric motor, adapted to drive the front wheels and the rear drive means include a rear motor, in particular a hydraulic motor or an electric motor, adapted to drive the rear wheels. The vehicle includes a main motor, in particular a combustion engine, and transmission means adapted to and configured for transmitting energy from the main motor to the front drive means and to the rear drive means. In particular, the transmission means include a distribution transmission and more particularly a pump transfer gear. The vehicle includes a distribution device for distributing a substance to an agricultural field, in particular for distributing liquid and/or powder to an agricultural field. The distribution device includes a tank for containing the substance and a distribution unit connected to the tank. At least one of the tires, and in particular all the tires, is/are tire(s) having a nominal minimum pressure of equal or below 1.5 bar, in particular equal to or below 1.3 bar and more preferably of: equal to or below 1.2 bar, 1.1 bar, 0.9 bar or 0.8 bar. At least one of the tires, and in particular all the tires, having a fluid pressure in the air chamber of smaller than 1.3 bars but higher than 1.1 bars or higher than 0.7 bars.

The invention relates also to a method of use of a vehicle having the following features. The method includes use of a vehicle characterized in that the vehicle is a vehicle as defined above. The method further includes use of a vehicle as defined above and further including detecting the vegetation on which the vehicle is to be displaced, setting the vegetation mode for the vehicle according the vegetation and executing at least one of the DRIVE STRATEGIES 1 to 4, as a function of the vegetation and of the terrain.

These are merely some of the innumerable aspects of the present disclosure and should not be deemed an all-inclusive listing of the innumerable aspects associated with the present disclosure. These and other aspects will become apparent to those skilled in the art in light of the following disclosure and accompanying drawings. The description and specific examples in this summary are intended for purposes of illustration only and are not intended to limit the scope of the present disclosure.

### BRIEF DESCRIPTION OF THE DRAWINGS

The accompanying drawings, which are incorporated in and form a part of the specification, illustrate the embodiments of the present disclosure and together with the description, serve to explain the principles of the disclosure.

FIG. 1 is a schematic side view of a vehicle according to the invention.

FIG. 2 is a schematic top view of the vehicle of FIG. 1.

FIG. 3 is a schematic block diagram of the vehicle of FIGS. 1 and 2 showing the functional features of the vehicle.

FIG. 4 is a schematic view of the wheels and axles of the vehicle during a first drive strategy.

FIG. 5 is a schematic view during a second drive strategy.

FIG. 6 is a schematic view during a third drive strategy.

Reference characters in the written specification indicate corresponding items shown throughout the drawing figures.

### DETAILED DESCRIPTION

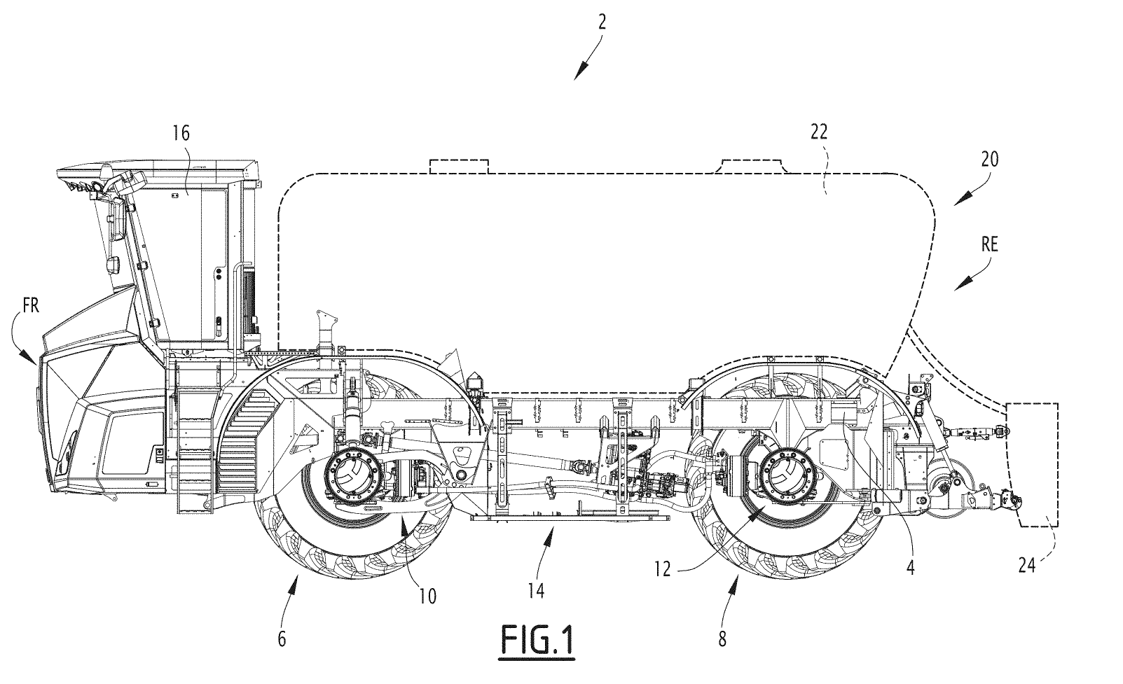

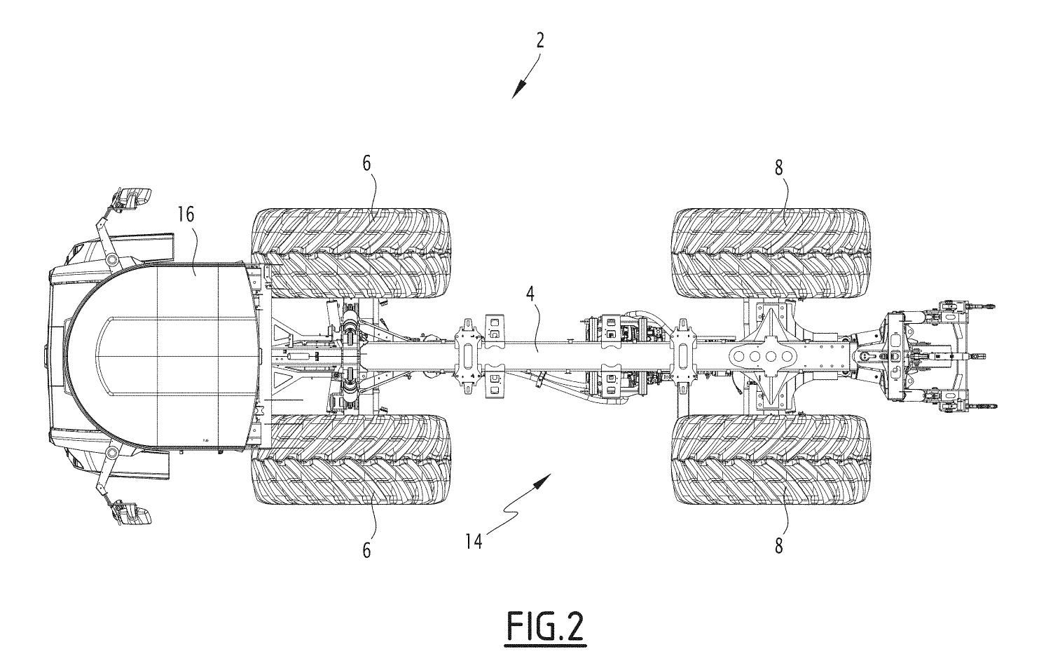

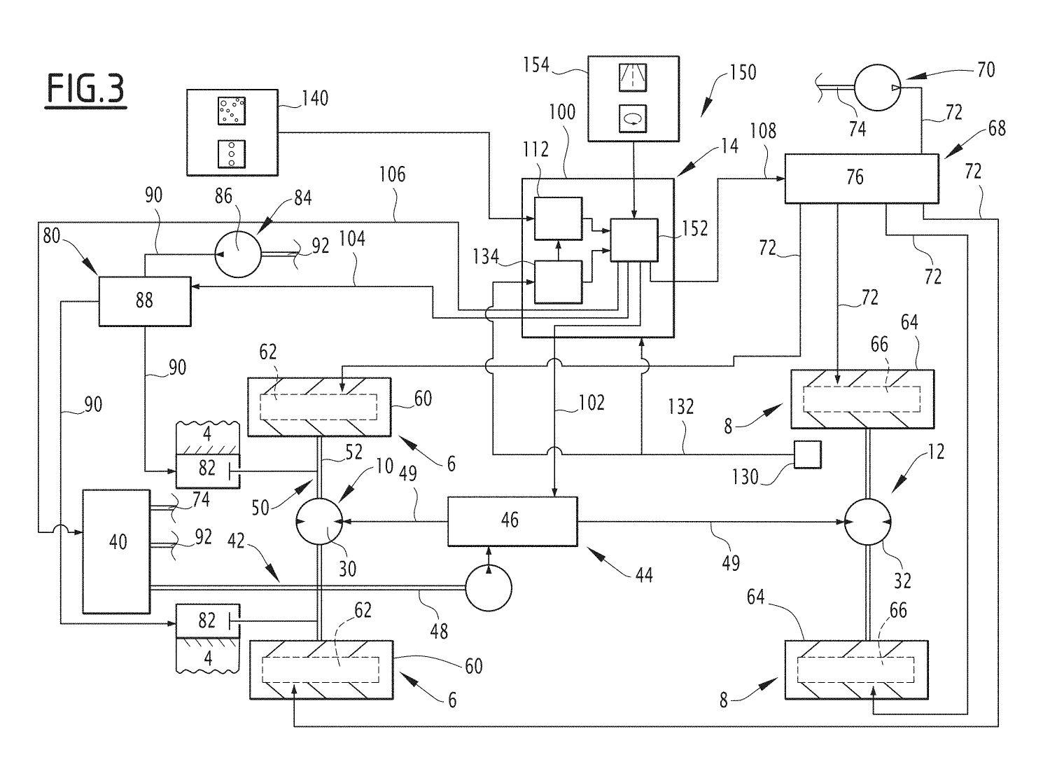

FIG. 1 shows a vehicle according to the invention designated by the general reference 2. The vehicle 2 is for example an agricultural vehicle adapted to distribute liquid manure to an agricultural field.

The vehicle 2 comprises a vehicle frame 4, front wheels 6 and rear wheels 8. The front wheels 6 comprise one left front wheel and one right front wheel. The rear wheels 8 comprise one left rear wheel and one right rear wheel, taken in the forward displacement direction F of the vehicle. The left front and left rear wheels are omitted on FIG. 1 for illustration purposes. Generally, the front wheels 6 comprise at least one front wheel and the rear wheels 8 comprise at least one rear wheel.

The vehicle 2 comprises furthermore front drive means 10 for driving the front wheels with a front nominal speed and rear drive means 12 for driving the rear wheels with a rear nominal speed. The vehicle comprises control means 14 adapted and configured for selectively controlling the front drive means 10 and the rear drive means 12 so that either the front nominal speed is different from the rear nominal speed or so that the front nominal speed is equal to the rear nominal speed. This means that the control means 14 are adapted and configured to, at any given instant during driving, controlling the front drive means 10 and the rear drive means 12 so that either the front nominal speed is different from the rear nominal speed or so that the front nominal speed is equal to the rear nominal speed. The control means 14 are thus adapted to switch between or select these two driving possibilities.

The difference between the front nominal speed and the rear nominal speed is defined as “lead”. The control means 14 are in particular adapted to control the front drive means 10 and the rear drive means 12 so that the front nominal speed is greater or smaller than the rear nominal speed. Generally and during forward driving, the front nominal speed is equal or greater than the rear nominal speed.

The front nominal speed is defined as the circumferential speed of the front wheels 6 when driven with a predetermined and nominal rotational speed. Likewise, the rear nominal speed is the circumferential speed of the rear wheels 8 at a nominal diameter and when driven with a nominal rotational speed. Generally, the front wheels 6 and rear wheels 8 have identical diameter, but the front wheels 6 can have a diameter different from the rear wheels 8. The wheel circumferential speed of the front wheels 6 and of the rear wheels 8 can be different from the front nominal speed respectively the rear nominal speed, due to wear of the wheels or due to a difference in air pressure, as will be explained later on.

The control means 14 are adapted to control the front drive means 10 and the rear drive means 12 so that the maximum difference between the front nominal speed and the rear nominal speed may be equal or greater than 4% and can for example be in the range from 5% to 7%. The lead itself is generally set between 0% and 5%, preferably between 2% and 4%. In other terms, when the lead in for example 4% and the rear wheels 8 are driven with a rotational speed corresponding to a determined rear nominal speed n, the front drive means 10 are controlled so that the front nominal speed is 1.04 times n.

More particularly, the control means 14 are adapted to control the front drive means 10 independently from the rear drive means 12 so that the front nominal speed can be set from zero to a maximum front nominal speed and the rear nominal speed can be set from zero to a maximum rear nominal speed independently from the front nominal speed. The vehicle 2 comprises a front F and a rear R as well as an operator cabin 16 fixed to the vehicle frame 4.

The vehicle 2 comprises a distribution device 20 adapted to distribute a substance to an agricultural field, in particular for distributing liquid, like liquid fertilizing agents, such as liquid manure, and/or powder to an agricultural field. The distribution device 20 comprises a tank 22 for containing the substance and a distribution unit 24 connected to the tank. Alternatively, the vehicle 2 comprises instead of a distribution device 20 another agricultural equipment or tool (not represented), such as a plough or a cultivator, for example as a tiller.

The front drive means 10 comprise a front motor 30 which is in the given instance a hydraulic motor and is adapted to drive the front wheels 6. The rear drive means 12 comprise a rear motor 32 which is in the example a hydraulic motor and which is adapted to drive the rear wheels 8. The front motor 30 and the rear motors are individual motors. The front motor 30 may be a common motor for all the front wheels 6, and the rear motor 32 may be a common motor for all the rear wheels 8. Alternatively and not represented the front motor 30 or the rear motor 32 or both can be electrical motors. In this case, the electrical motors are independently driven or driven one from another.

The vehicle comprises also a main motor 40, in particular a combustion engine, and transmission means 42 adapted to and configured for transmitting energy from the main motor 40 to the front drive means 10 and to the rear drive means 12, in particular the transmission means 42 comprising a distribution transmission 44 and more particularly a pump transfer gear 46. The distribution transmission 44 is for example driven by an output shaft 48 of the main motor 40. The distribution transmission 44 has an output which is connected by a transmission line 49 to the front motor 30 and another output which is connected by a transmission line 49 to the rear motor 32. The transmission lines are in the present case hydraulic lines.

The vehicle comprises an adjustable link 50 adjustably linking the front wheels 6 so that the position of the front wheels 6 is adjustable with respect to the position of the rear wheels 8 and with respect to the vehicle frame 4. The adjustable link 50 comprises in particular a mobile axle 52 mobile with respect to the vehicle frame 4, or a single suspension of each front wheel 6 on the vehicle frame. Alternatively, the rear wheels 8 are linked to the vehicle frame 4 in an adjustable manner via the adjustable link 50. In this case the features which are disclosed with respect to the adjustable link at the front wheels apply in an analogous manner to the rear wheels.

Furthermore, at least one of the front wheels 6, in particular each front wheel 6, comprises a front tire 60 having a front air chamber 62, and/or at least one of the rear wheels 8, in particular each rear wheel 8, comprises a rear tire 64 having a rear air chamber 66. The vehicle comprises furthermore a pressure control device 68 adapted to and configured for controlling the fluid pressure, namely the air pressure, in at least one of the front air chambers 62 and/or rear air chambers 66 and preferably in each of the air chambers.

To this end, the pressure control device 68 comprises a pressurized fluid source 70, such as an air compressor preferably driven by the main motor 40 over a shaft 74. The pressure control device 68 comprises also a pressure line 72 for providing pressurized fluid from the fluid source 70 to one of each of the air chambers, i.e. the front air chambers 62 and the rear air chambers 66. The pressure control device 68 comprises also a distribution valve 76, inserted in pressure line 72 adapted to selectively and individually control pressurized fluid flow from the pressurized fluid source 70 to each of the air chambers 62, 66. The pressure control device can also comprise for each air chamber, a pressure sensor (not depicted) adapted and configured for detecting the fluid pressure in the respective air chamber. The pressure sensor(s) are used by the pressure control device for regulating the pressure in the air chambers.

At least one and in particular all the tires are tires which allow driving the vehicle while the nominal pressure in the air chamber of the respective tire is rather low. This allows for a large tread surface which reduces pressure on the soil and increases traction. The tires have preferably a nominal minimum pressure in the air chamber of equal to or below 1.5 bar, in particular of equal to or below 1.3 bar and more preferably of equal to or below 1.2 bar. The tires can be for examples tires sold under the trade name “Michelin VF 900/60 R38 Cerexbib 2”. The tires may also have a nominal minimum pressure of equal to or below 1.1 bar, in particular of equal to or below 0.9 bar and in particular or equal to or below 0.8 bar.

The vehicle comprises a link control device 80 adapted and configured to adjust the adjustable link 50. The link control device 80 comprises two actuators 82, in the present case two combined suspension and gradient cylinders, each one fixed to the vehicle frame 4 and to one of the axles of the front wheels 6. The link control device 80 comprises actuator drive means 84, for example a hydraulic pump 86, a control valve 88 and a hydraulic line 90 from the hydraulic pump 86 via the control valve to the actuators 82, allowing selectively locking or releasing the gradient part of the cylinder.

The actuator drive means 84 are preferably driven by the main motor, in the present case driven by an output shaft 92 of the main motor 40.

The vehicle 2 comprises a control unit 100 that is adapted to and configured for controlling each of the components of the vehicle. The control unit 100 can be embodied as a computer including any combination of digital and analog computing means, such as processor, memory, input/output.

The vehicle 2 comprises a drive control line 102 linked to the front drive means 10 and to the rear drive means 12, in the present case linked to the pump transfer gear 46, a link control line 104 adapted to control the link control device 80, in the present case linked to the control valve 88, a main motor control line 106, linked to the main motor 40, a pressure control line 108, linked to the pressure control device 68, in the present case to the distribution valve 76. The control lines can be embodied by individual signal lines, or by a bus system, or by any other technical feasible control line means.

The vehicle 2 comprises drive mode control means 112, which can be embodied by the control unit 100, defining one or more of the following drive modes of the vehicle: A) a neutral drive mode in which the front nominal speed is set equal to the rear nominal speed; B) a small lead drive mode in which the front nominal speed is higher than the rear nominal speed, in particular the difference being in a range from 0% to 3%; and C) a high lead drive mode in which the front nominal speed is higher than the rear nominal speed and the difference in front nominal speed to the rear nominal speed is higher than in the small lead drive mode, in particular the difference being in a range from 2 to 5%.

In particular, in the small lead drive mode, the speed difference range can be smaller than 2.5% and in the high lead drive mode, the speed difference can be greater than 2.5%. While the ranges of the small lead and high lead ranges overlap, for a given instance in one vehicle 2 of a small and a high lead drive mode, the small lead difference is smaller than the high lead difference.

To this end, the drive mode control means 112, is linked to the drive control line 102.

The vehicle 2 comprises lateral inclination information means 130, in particular a lateral inclination sensor, adapted to and configured for indicating the lateral inclination of the vehicle frame or of the soil on which the vehicle is placed with respect to a horizontal plane. The lateral inclination sensor is for example an accelerometer arranged on the rear axle of the vehicle. The lateral inclination means 130 can also comprise memory means representing a map and inclination information of the terrain and position and heading generating means, such as a GPS. The lateral inclination information means 130 is connected to the control means 14 or the control unit 100, more particularly to the drive mode control means 112, via a sensor line 132.

The vehicle 2 comprises terrain mode control means 134, embodied for example by a portion of the control unit 100, and are adapted to and configured for controlling the front drive means 10 and the rear drive means 12 according to one of the two following terrain modes: A) horizontal plane terrain mode, executed when the lateral inclination information means 130 indicate a horizontal position of the vehicle or a position of the vehicle on a slope, the longitudinal axis of the vehicle being positioned parallel to a slope so that the front wheels 6 are at a same level and the rear wheels 8 are at a same level; and B) lateral inclination terrain mode, executed when the lateral inclination information means 130 indicate a lateral inclination of the vehicle with respect to a horizontal plane.

In other words, when the vehicle is positioned parallel to the slope, the vehicle is strictly facing “uphill” or “downhill”. When the vehicle has a lateral inclination, it is facing transversal to an “uphill” or “downhill” direction.

In the present embodiment, the terrain control means 134 include a sub-unit within the control unit 100 connected to the drive mode control means 112.

The control means 14 or the control unit 100 are adapted to and configured for controlling the lead as a function of the lateral inclination information.

Furthermore, the pressure control device 68 and/or the control unit 100 is adapted to and configured for adjusting the fluid pressure in at least one of the front air chambers 62 and/or rear air chambers 66, and in particular in each of these air chambers, as a function of the lateral inclination information. To this end, the control unit 100 is linked to the distribution valve 76 via the pressure control line 108.

The link control device 80 and/or the control unit 100 is adapted to control the position of the front wheels 6 and/or of the rear wheels 8 with respect to the vehicle frame 4 based on the information of the lateral inclination information means 130. In particular, when a lateral inclination is detected, the actuators 82 are locked in the same position, so that the nominal position of both front wheels is identical and both front wheels have a mechanical behavior with respect to the vehicle frame 4 as if linked by a rigid axle which is suspended to the vehicle frame 4.

The vehicle 2, in particular the control means 14, comprise a vegetation selector 140 adapted to and configured for switching the control means 14 into one of the following vegetation modes, indicating the vegetation type on which the vehicle is displaced: A) Grassland mode—The terrain comprises one or more of the following: Grass land, standing plants, stubble, intermediate crops; and B) Row crop mode—The terrain comprises row crops or the terrain comprises wheel tracks.

Based on the information of the vegetation selector 140 and the lateral inclination information means 130, the control means 14, in the present embodiment the control unit 100, are adapted and configured for controlling the vehicle according to one, several or all of the following drive strategies: DRIVE STRATEGY 1: Vegetation mode=Grassland mode and Terrain mode=horizontal plane terrain mode: the vehicle is driven in neutral drive mode and a first, namely a relatively small, air chamber pressure is set, and preferably the air chamber pressure is set to be identical in each air chamber (The fluid pressure in the air chambers is for example smaller than 1.3 bars but higher than 1.1 bars or higher than 0.7 bars); DRIVE STRATEGY 2: Vegetation mode=Grassland mode and Terrain mode=lateral inclination terrain mode: the vehicle is driven in small lead drive mode and the air chamber pressure is adjusted as a function of the lateral inclination so that a lower ground wheel has an air pressure higher than the corresponding higher ground wheel; DRIVE STRATEGY 3: Vegetation mode=Row crop mode and Terrain mode=horizontal plane terrain mode: the vehicle is driven in neutral drive mode and the air pressure is adjusted as a function of a needed traction force; and DRIVE STRATEGY 4: Vegetation selector=Row crop mode and Terrain mode=lateral inclination terrain mode: the vehicle is driven in high lead drive mode and the air chamber pressure is adjusted as a function of the lateral inclination so that a lower ground wheel has an air pressure higher than the corresponding higher ground wheel.

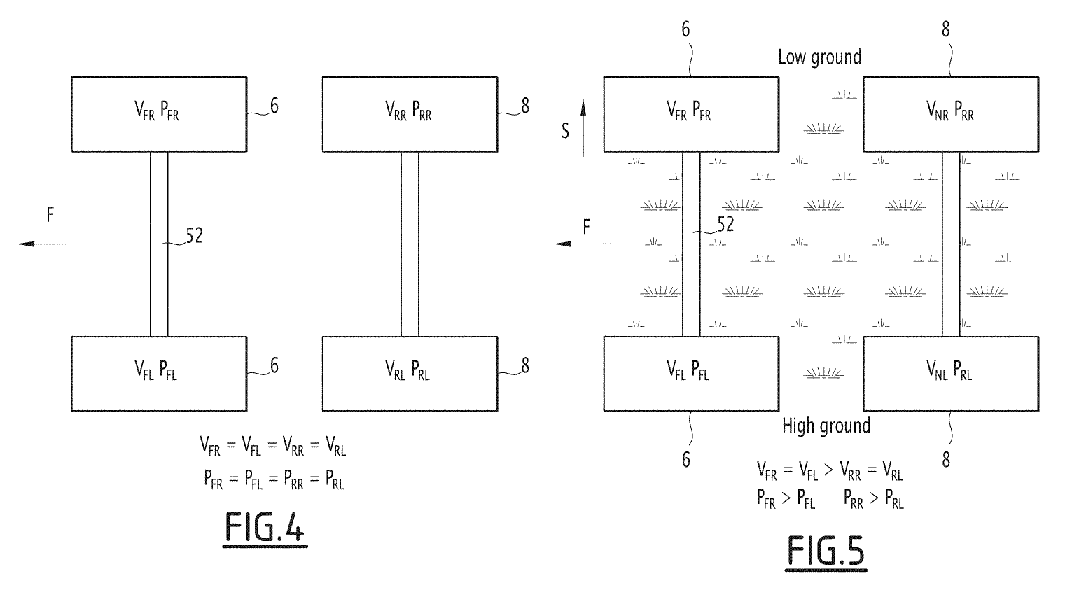

The principle of DRIVE STRATEGY 1 is indicated in FIG. 4. The nominal speed of each wheel is indicated with “Vxx” and the pressure in the air chamber by “Pxx”, the index xx is FR,FL,RR,RL which indicates the front right, front left, rear right and rear left tire respectively. The front drive direction is indicated by F and corresponds to the direction of the front FR of the vehicle. However the front drive direction may correspond to the direction of the rear of the vehicle in case of reverse drive. In this drive strategy, the actuators 82 are set free, so that the front wheels 6 are suspended individually with respect to the vehicle frame 4.

The principle of DRIVE STRATEGY 2 is shown in FIG. 5. The vehicle is driving on laterally inclined ground perpendicular to a slope S and the front right wheel 6 and the rear right wheel 8 are respectively lower than the front left wheel 6 and the rear left wheel 8. Consequently, the nominal speeds of the front wheels VFL and VFR are set identical and the nominal speeds of the rear wheels VRL and VRR are set identical, but the nominal speed of the front wheels is higher than the nominal speed of the rear wheels. In addition, the pressure in the air chambers of the lower ground wheels, in the present case the front right wheel and the rear right wheel is set higher than the pressure in the higher ground wheels, in the present case the front left wheel and the front rear wheel. In this drive strategy, the actuators 82 are locked in the same position, so that the nominal position of both front wheels is identical and both front wheels have a mechanical behavior with respect to the vehicle frame 4 as if linked by a rigid axle which is suspended to the vehicle frame 4.

In DRIVE STRATEGY 3, additionally to the vehicle being driven in neutral drive mode, similar to the situation in FIG. 4, the air pressure is adjusted as a function of a needed traction force. In case a higher traction force is needed, the pressure in the air chambers 62, 66 is reduced for example by a value comprised between 0.1 to 0.5 bar, in case a lower traction force is needed, the pressure in the air chambers 62, 66 is increased, for example by a value comprised between 0.1 to 0.5 bar. In this drive strategy, the actuators 82 are set to identical positions, so that the nominal position of all of the wheels with respect to the vehicle frame 4 is identical.

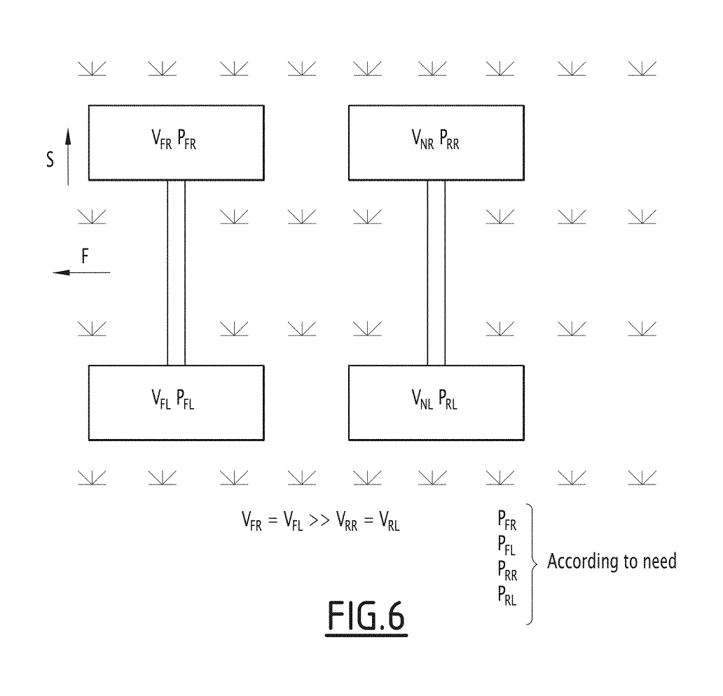

The principle of DRIVE STRATEGY 4 is shown in FIG. 6. The vehicle is driving on laterally inclined ground perpendicular to a slope S and the front right wheel 6 and the rear right wheel 8 are respectively lower than the front left wheel 6 and the rear left wheel 8. Consequently, the nominal speeds of the front wheels VFL and VFR are set identical and the nominal speeds of the rear wheels VRL and VRR are set identical, but the nominal speed of the front wheels is higher than the nominal speed of the rear wheels and higher than the difference during DRIVE STRATEGY 2. In addition, the pressure in the air chambers of the lower ground wheels, in the present case the front right wheel and the rear right wheel is set higher than the pressure in the higher ground wheels, in the present case the front left wheel and the front rear wheel. Additionally, in this drive strategy, the actuators 82 are locked in the same position, so that the nominal position of both front wheels is identical and both front wheels have a mechanical behavior with respect to the vehicle frame 4 as if linked by a rigid axle which is suspended to the vehicle frame 4.

The control means comprise supplemental drive strategy means 150 adapted to and configured for controlling the vehicle according to at least one supplementary drive strategy. The supplemental drive strategies comprise a supplemental drive strategy unit 152 of the control unit 100 and which is adapted to and configured for modifying the DRIVE STRATEGIES 1 to 4. The supplemental drive strategy unit 152 is inserted in the signal path of the control unit 100 from the drive mode control means 112 to the drive control line 102, the link control line 104, the main motor control line 106, and the pressure control line 108.

The vehicle 2, in particular the control means 14, comprise a supplementary drive strategy selector 154 adapted to and configured for switching the supplemental drive strategy unit 152 into one or more of the supplementary drive strategies, explained below.

The supplemental drive strategy means 150 is adapted to apply one, several or all of the following supplementary drive strategies, which are applicable in addition and preferably simultaneously with each of the DRIVE STRATEGIES 1 to 4:

DRIVE STRATEGY 5:—Turn mode: Supplementary to the selected drive strategy among the DRIVE STRATEGY 1 to 4: the lead is increased with respect to the applied DRIVE STRATEGY 1 to 4. Preferably, the lead is increased at least by 1 point increase, i.e. in case the lead is 1%, it is set to 2%. The remaining drive parameters of the applied DRIVE STRATEGY 1 to 4 are not altered.

DRIVE STRATEGY 6—Reverse drive: With respect to the applied DRIVE STRATEGY 1 to 4, additionally the front nominal speed is applied to the rear wheels with a reverse rotation direction and the rear nominal speed is applied to the front nominal speed with a reverse direction. This drive strategy results in the vehicle driving backwards with the rear wheels being driven with the front nominal speed but with reversed direction and the front wheels being driven with the rear nominal speed but with reversed direction. The remaining drive parameters of the applied DRIVE STRATEGY 1 to 4 are not altered.

DRIVE STRATEGY 7—Road travel: The neutral drive mode is set and the air chamber pressure is set to being higher than during the DRIVE STRATEGY 1 to 4, in particular the air chamber pressure is at least 0.1 bar and in particular 0.4 bar higher than during DRIVE STRATEGIES 1 to 4.

The supplemental drive strategy means 150 is also adapted to apply none of the supplementary drive strategies, thus leaving the DRIVE STRATEGIES 1 to 4 unamended. This is achieved by a neutral mode of the supplemental drive strategy means 150.

During use of the vehicle, the operation is as follows.

For treating an agricultural field via forward drive and straight travel, the operator selects via the vegetation selector 140 the vegetation type of the agricultural field to be treated (Grassland or row crop) and sets the supplementary strategy selector 154 to neutral or off. The vehicle 2 is then driven using one of the DRIVE STRATEGIES 1 to 4 along the field in an essentially straight line. Depending on the inclination detected by the sensor 130, the control means switch between the corresponding drive strategies with the terrain being “laterally inclined” or “horizontal”. Thanks to the DRIVE STRATEGIES 1 to 4, depending on the need of the field to be treated, the vehicle 2 keeps in track, is stable and protects the crop on the field as well as the soil. The stress on the operator due to manual intervention in the control process of the vehicle is low.

When the vehicle is to be driven on streets, the driver indicates “street travel” to the vehicle by selecting the corresponding drive strategy on the supplementary drive strategy selector 154.

When the vehicle is to be driven at a turn at an end of row, the “turn” mode is selected, and the corresponding supplementary drive strategy executed.

Generally, the use of the vehicle includes executing at least one of the DRIVE STRATEGIES 1 to 4, as a function of the vegetation and of the terrain.

During use of the vehicle at least one, several or all of the following method steps are executed:

The vehicle is driven and, in particular during neutral drive mode, the wheels are driven so that the front nominal speed is set equal to the rear nominal speed

The vehicle is driven, and in particular during small lead drive mode, the wheels are drive so that the front nominal speed is higher than the rear nominal speed, in particular in a range from 0% to 3%

The vehicle is driven and, in particular during high lead drive mode, the wheels are driven so that the front nominal speed is higher than the rear nominal speed and the difference in front nominal speed to the rear nominal speed is higher than in the small lead drive mode, in particular the difference (lead) being in a range from 2 to 5%.

The method includes detecting the lateral inclination of the vehicle frame or of the soil on which the vehicle is placed with respect to a horizontal plane and controlling the front drive means and the rear drive means based on the lateral inclination detected, and controlling the lead as a function of the detected lateral inclination.

The method includes selecting, based on the vegetation type on which the vehicle is displaced, one of the following vegetation modes: Grassland mode, when the terrain comprises one or more of Grass land, standing plants, stubble, and intermediate crops; and Row crop mode, when the terrain comprises row crops or the terrain comprises wheel tracks, and once the vegetation mode is selected, displacing the vehicle on the corresponding terrain.

The method includes controlling the vehicle according to one, several or all of the following drive strategies: DRIVE STRATEGY 1, when the Vegetation mode=Grassland mode and the Terrain mode=horizontal plane terrain mode, driving the vehicle is in neutral drive mode; DRIVE STRATEGY 2, when the vegetation mode=Grassland mode and the terrain mode=lateral inclination terrain mode, driving the vehicle in small lead drive mode; DRIVE STRATEGY 3: when the vegetation mode=Row crop mode and the terrain mode=horizontal plane terrain mode, driving the vehicle in neutral drive mode; and DRIVE STRATEGY 4, when the vegetation selector=Row crop mode and the terrain mode=lateral inclination terrain mode, driving the vehicle in high lead drive mode.

The method includes controlling the fluid pressure, in particular the air pressure, in at least one of the front and/or rear air chambers, and in particular in each of the air chambers.

The method includes in DRIVE STRATEGY 1 setting a first, namely a relatively small, air chamber pressure, and preferably setting the air chamber pressure to be identical in each air chamber, in DRIVE STRATEGY 2 adjusting the air chamber pressure as a function of the lateral inclination, so that a lower ground wheel has an air pressure higher than the corresponding higher ground wheel, in DRIVE STRATEGY 3 adjusting the air pressure as a function of a needed traction force, and in DRIVE STRATEGY 4 adjusting the air chamber pressure as a function of the lateral inclination, so that a lower ground wheel has an air pressure higher than the corresponding higher ground wheel.

The method includes controlling the vehicle according to one, several or all of the following supplementary strategies by applying them in addition and preferably simultaneously to each of the DRIVE STRATEGIES 1 to 4: DRIVE STRATEGY 5—Turn mode, supplementary to the selected drive strategy among DRIVE STRATEGY 1 to 4 increasing the lead is increased with respect to the applied DRIVE STRATEGY 1 to 4, in particular increasing the lead at least by 1% point increase and for example by at most 2% point increase; DRIVE STRATEGY 6—Reverse drive—with respect to the applied DRIVE STRATEGY 1 to 4 applying the front nominal speed to the rear wheels with a reverse rotation direction and applying the rear nominal speed to the front nominal speed with a reverse direction; and DRIVE STRATEGY 7—Road travel setting the neutral drive mode and the air chamber pressure is set to being higher than during the corresponding DRIVE STRATEGY 1 to 4, in particular the air chamber pressure is at least 0.1 bar and in particular 0.4 bar higher than during DRIVE STRATEGIES 1 to 4.

The method includes controlling the front drive means and the rear drive means so that the maximum difference between the front nominal speed and the rear nominal speed is greater than 1%, preferably greater or equal than 2% and more preferably between 2 and 4%. The method includes controlling the front drive means independently from the rear drive means, namely the front nominal speed can be set from zero to a maximum front nominal speed and the rear nominal speed can be set from zero to a maximum rear nominal speed independently from the front nominal speed.

The names of the drive strategies and the modes are chosen for illustration purposes only. The exact names for these modes could be different, as long as the associated function is achieved.

While in the above embodiment the different features of the specific embodiment have been disclosed together it should not be implied that these features are exclusively to be used together. In particular, the features related to the following aspects can be used independently from one another or can be omitted:

The features related to the pressure control in the tires. The vehicle can be used with tires having no pressure control or with wheels having full rubber tires

The features relating to the suspension of the wheels. The wheels may be suspended to the vehicle frame 4 or may not be suspended to it.

The features related to the lateral inclination information means. The vehicle may or may not have these means 130 and the corresponding control means.

The features relating to the specific drive arrangement with individual motors. the vehicle may have front drive means and rear drive means that are dependent one from another. Likewise, the vehicle may have the one or more of the features relating of the front drive and rear drive means, but without or only with some of the remaining features relating to the drive control.

According to other aspects, the vehicle of the present invention may have one or more of the following features:

The vehicle comprises an adjustable link adjustably linking the front wheels or the rear wheels to the vehicle frame, so that the position of the front wheels is adjustable with respect to the position of the rear wheels and with respect to the vehicle frame, in particular the adjustable link comprising a mobile axle or a single suspension.

In the lateral inclination terrain mode the pressure control device is adapted to and configured for adjusting the fluid pressure in at least one of the front and/or rear air chambers, and in particular in each of the air chambers, as a function of the lateral inclination information.

The air chamber of the tires is a space receiving air or another fluid under pressure and can be formed by a tube or by the interior space of a tubeless tire. The tires can therefore be tube tires or tubeless tires.

In view of the foregoing, it will be seen that the several advantages of the disclosure are achieved and attained.

The embodiments were chosen and described in order to best explain the principles of the disclosure and its practical application to thereby enable others skilled in the art to best utilize the disclosure in various embodiments and with various modifications as are suited to the particular use contemplated.

As various modifications could be made in the constructions and methods herein described and illustrated without departing from the scope of the disclosure, it is intended that all matter contained in the foregoing description or shown in the accompanying drawings shall be interpreted as illustrative rather than limiting. Thus, the breadth and scope of the present disclosure should not be limited by any of the above-described exemplary embodiments, but should be defined only in accordance with the following claims appended hereto and their equivalents.

What is claimed is:

1. A vehicle comprising:
a vehicle frame, front wheels, and rear wheels;
front drive means for driving the front wheels with a front nominal speed;
rear drive means for driving the rear wheels with a rear nominal speed; and
control means adapted and configured for selectively controlling the front drive means and the rear drive means so that either the front nominal speed is different from the rear nominal speed, or so that the front nominal speed is equal to the rear nominal speed, a difference between the front nominal speed and the rear nominal speed being defined as lead.

2. A vehicle according to claim 1, wherein the control means are adapted and configured for selectively controlling the front drive means and the rear drive means so that the front nominal speed is greater or smaller than the rear nominal speed.

3. A vehicle according to claim 1, wherein the vehicle comprises drive mode control means defining one or more of the following drive modes:
A) a neutral drive mode in which the front nominal speed is set equal to the rear nominal speed;
B) a small lead drive mode in which the front nominal speed is higher than the rear nominal speed and
C) a high lead drive mode in which the front nominal speed is higher than the rear nominal speed and the difference in front nominal speed to the rear nominal speed is higher than in the small lead drive mode.

4. A vehicle according to claim 3, wherein, in the small lead drive mode, the front nominal speed is higher than the rear nominal speed in a range from 0% to 3%.

5. A vehicle according to claim 3, wherein in the high lead drive mode the front nominal speed is higher than the rear nominal speed and the difference in front nominal speed to the rear nominal speed is in a range from 2% to 5%.

6. A vehicle according to claim 3, wherein the vehicle comprises lateral inclination information means adapted to and configured for indicating the lateral inclination of the vehicle frame or of the soil on which the vehicle is placed with respect to a horizontal plane, wherein the lateral inclination information means is connected to the control means, and wherein the control means are adapted to and configured for controlling the front drive means and the rear drive means according to one of the two following terrain modes:
a horizontal plane terrain mode, executed when the lateral inclination information means indicate a horizontal position of the vehicle or a position of the vehicle parallel to a slope, and
a lateral inclination terrain mode, executed when the lateral inclination information means indicate a lateral inclination of the vehicle with respect to a horizontal plane, and
wherein the control means are adapted to and configured for controlling the lead as a function of the lateral inclination information.

7. A vehicle according to claim 6, wherein the lateral inclination information means comprise a lateral inclination sensor.

8. A vehicle according to claim 6, wherein the control means comprise a vegetation selector adapted to and configured for switching the control means into one of a plurality of vegetation modes, indicating the vegetation type on which the vehicle is displaced, the plurality of vegetation modes including:
a grassland mode corresponding to terrain comprising one or more of the following: grass land, standing plants, stubble, and intermediate crops; and
a row crop mode corresponding to terrain comprising row crops or wheel tracks; and
wherein the control means are adapted and configured for controlling the vehicle according to one, several, or all of the following drive strategies:
a DRIVE STRATEGY 1 wherein the vegetation mode is the grassland mode and the terrain mode is the horizontal plane terrain mode, and wherein the vehicle is driven in the neutral drive mode;
a DRIVE STRATEGY 2 wherein the vegetation mode is the grassland mode and the terrain mode is the lateral inclination terrain mode, and wherein the vehicle is driven in the small lead drive mode;
a DRIVE STRATEGY 3 wherein the vegetation mode is the row crop mode and the terrain mode is the horizontal plane terrain mode, and wherein the vehicle is driven in the neutral drive mode; and
a DRIVE STRATEGY 4 wherein the vegetation mode is the row crop mode and the terrain mode is the lateral inclination terrain mode, and wherein the vehicle is driven in the high lead drive mode.

9. A vehicle according to claim 1, wherein at least one of the front wheels comprises a front tire having a front air chamber, wherein at least one of the rear wheels comprises a rear tire having a rear air chamber, and wherein the vehicle comprises a pressure control device adapted to and configured for controlling the fluid pressure in at least one of the front or rear air chambers.

10. A vehicle according to claim 9, wherein each of the front wheels comprises a front tire having a front air chamber, and each of the rear wheels comprises a rear tire having a rear air chamber, and the pressure control device is adapted to and configured for controlling the fluid pressure in each of the air chambers.

11. A vehicle according to claim 9, wherein the fluid pressure is air pressure.

12. A vehicle according to claim 8, wherein at least one of the front wheels comprises a front tire having a front air chamber, wherein at least one of the rear wheels comprises a rear tire having a rear air chamber, and wherein the vehicle comprises a pressure control device adapted to and configured for controlling the fluid pressure in at least one of the front or rear air chambers, and wherein:
in DRIVE STRATEGY 1 a first, namely a relatively small, air chamber pressure is set;
in DRIVE STRATEGY 2 the air chamber pressure is adjusted as a function of the lateral inclination so that a lower ground wheel has an air pressure higher than a corresponding higher ground wheel;
in DRIVE STRATEGY 3 the air pressure is adjusted as a function of a needed traction force; and
in DRIVE STRATEGY 4 the air chamber pressure is adjusted as a function of the lateral inclination so that a lower ground wheel has an air pressure higher than a corresponding higher ground wheel.

13. A vehicle according to claim 12 wherein in DRIVE STRATEGY 1 the air chamber pressure is set to be identical in each air chamber.

14. A vehicle according to claim 9, wherein the control means are adapted and configured for controlling the vehicle according to one, several or all of the following supplementary strategies, which are applied in addition and preferably simultaneously to each of the DRIVE STRATEGIES 1 to 4:
a DRIVE STRATEGY 5, a turn mode wherein supplementary to the selected drive strategy among DRIVE STRATEGY 1 to 4, the lead is increased with respect to the applied DRIVE STRATEGY 1 to 4;
a DRIVE STRATEGY 6, a reverse drive mode wherein with respect to the applied DRIVE STRATEGY 1 to 4, additionally the front nominal speed is applied to the rear wheels with a reverse rotation direction and the rear nominal speed is applied to the front nominal speed with a reverse direction; and
a DRIVE STRATEGY 7, a road travel mode, wherein the neutral drive mode is set and the air chamber pressure is set to being higher than during the DRIVE STRATEGY 1 to 4.

15. A vehicle according to claim 14, wherein in DRIVE STRATEGY 5, the turn mode, the lead is increased at least by 1% point increase and in DRIVE STRATEGY 7, the road travel mode, the air chamber pressure is at least 0.1 bar higher than during DRIVE STRATEGIES 1 to 4.

16. A vehicle according to claim 1, wherein the control means are adapted to control the front drive means and the rear drive means so that the maximum difference between the front nominal speed and the rear nominal speed is greater than 1%.

17. A vehicle according to claim 16, wherein the control means are adapted to control the front drive means and the rear drive means so that the maximum difference between the front nominal speed and the rear nominal speed is greater than or equal to 2%.

18. A vehicle according to claim 17, wherein the control means are adapted to control the front drive means and the rear drive means so that the maximum difference between the front nominal speed and the rear nominal speed is between 2 and 4%.

19. A vehicle according to claim 16, wherein the control means are adapted to control the front drive means independently from the rear drive means, namely the front nominal speed can be set from zero to a maximum front nominal speed and the rear nominal speed can be set from zero to a maximum rear nominal speed independently from the front nominal speed.

20. A vehicle according to claim 1, wherein the front drive means comprise a front motor adapted to drive the front wheels, and wherein the rear drive means comprise a rear motor adapted to drive the rear wheels.

21. A vehicle according to claim 20, wherein the front motor is a hydraulic motor or an electric motor and wherein the rear motor is a hydraulic motor or an electric motor.

22. A vehicle according to claim 20, wherein the vehicle comprises a main motor and transmission means adapted to and configured for transmitting energy from the main motor to the front drive means and to the rear drive means.

23. A vehicle according to claim 22, wherein the main motor is a combustion engine and the transmission means comprise a distribution transmission.

24. A vehicle according to claim 23, wherein the distribution transmission is a pump transfer gear.

25. A vehicle according to claim 1, wherein the vehicle comprises a distribution device for distributing a substance to an agricultural field, and wherein the distribution device comprises a tank for containing the substance and a distribution unit connected to the tank.

26. A vehicle according to claim 25, wherein the device for distributing a substance to an agricultural field is adapted to distribute one or more of a liquid and a powder to an agricultural field.

27. A vehicle according to claim 1 wherein at least one of the tires is a tire having a nominal minimum pressure of equal or below 1.5 bar and the at least one of the tires has a fluid pressure in the air chamber of smaller than 1.3 bars and higher than 0.7 bars.

28. A method for controlling a vehicle according to claim 8, the method comprising use of the vehicle in traversing a distance.

29. A method according to claim 28 further comprising detecting the vegetation on which the vehicle is to be displaced, setting the vegetation mode for the vehicle according the vegetation and executing at least one of the DRIVE STRATEGIES 1 to 4, as a function of the vegetation and of the terrain.
